(19) United States
(12) Patent Application Publication
(10) Pub. No.: US 2016/0296828 A1
(43) Pub. Date: Oct. 13, 2016

(54) Brake Systems for Inline Skates

(71) Applicant: Burton J. Ewing, JR., Coon Rapids, MN (US)

(72) Inventor: Burton J. Ewing, JR., Coon Rapids, MN (US)

(21) Appl. No.: 15/093,689

(22) Filed: Apr. 7, 2016

Related U.S. Application Data
(60) Provisional application No. 62/143,908, filed on Apr. 7, 2015.

(51) Int. Cl. A63C 17/14; B60T 11/04; B60T 7/10

(52) U.S. Cl. CPC A63C 17/1427; A63C 17/1409; B60T 7/108; B60T 11/046; A63C 2017/1472; A63C 17/06

(57) ABSTRACT

One or more sets of dual brake pads and related assemblies are disposed over and upon one or more wheels of an inline skate. One or more center assemblies are above each brake enabled wheel and center over each wheel. A brake assembly may be secured to a skate boot or to the frame of an inline skate. A brake assembly may attach to a hand control braking system enabling foot free braking. A brake assembly may be attached to one or more center wheels of an inline skate so as to not impede skating maneuvers.

### CROSS-REFERENCE TO RELATED APPLICATIONS

This is a utility application based upon U.S. patent application Ser. No. 62/143,908 filed on Apr. 7, 2015. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### BACKGROUND OF THE INVENTION

(1) Field of the Invention

The invention generally relates to brake systems. More particularly, the invention relates to means and methods of using bicycle braking components and other brake components on skates, such as inline skates.

(2) Description of the Related Art

The known related art fails to anticipate or disclose the principles of the present invention.

In the related art various braking systems are known for both roller skates and inline skates. For example, U.S. Pat. No. 5,330,207 granted to Mitchell on Jul. 19, 1994 discloses a rear pad applied to the rear section of the rear wheel. Mitchell fails to disclose or contemplate hand controls for braking.

U.S. Pat. No. 5,829,543 granted to Diaz on Nov. 3, 1998 discloses a motorized inline skate system with a hand control for braking, but the brake comprises a rear cross block to the rear wheel only. Such a brake impedes the balance of the user, as a backwards bias is created during braking.

In the current art, roller blade users or inline skaters must lean back on one skate to engage a back brake or back block. Such a maneuver places the user at risk of falling.

Thus, there is a need in the art for the present invention.

### BRIEF SUMMARY OF THE INVENTION

The present invention overcomes shortfalls in the related art by presenting an unobvious and unique combination and configuration of methods and components to use bicycle components to retard the movement of skate wheels. In one disclosed embodiment, bike wheel or bike tire pads are disposed on one side or on both sides of a wheel or wheels. In a disclosed embodiment, bike brake pads are disposed on either side of one or two middle wheels so as to not disrupt the balance of the user.

The invention overcomes shortfalls in the related art by using hand activated cable pull systems to operate the wheel brakes. The hand pull system allows the skater to remain balanced and not lean back as currently required in the prior art.

These and other objects and advantages will be made apparent when considering the following detailed specification when taken in conjunction with the drawings.

### BRIEF DESCRIPTION OF THE DRAWINGS

FIG. 1 depicts two inline skates with disclosed brake components

FIG. 2 depicts one inline skate with disclosed brake components

FIG. 3 depicts a brake assembly

FIG. 4 depicts a brake assembly

### REFERENCE NUMERALS IN THE DRAWINGS

100 inline skate

105 boot of inline skate

106 frame of inline skate

120 wheels of an inline skate, such as outer wheels

140 back stopper

200 hand controls for a disclosed brake system

210 cables attached to the hand controls 200

220 a bike type brake system

221 center pivot and attachment assembly of brake system 220

222 first curved leg of brake system 220

223 second curved leg of brake system 220

224 alternative attachment area of first curved leg 222

225 first cable attachment end of first curved leg 222

226 second cable attachment end of second curved leg 223

240 brake pads of a disclosed embodiment

250 center wheel of an inline skate

300 alternative brake system

305 first leg of alternative brake system 300

310 pivotal attachment between first leg 305 and horizontal member 315

315 horizontal member of alternative brake system 300

316 tip section of horizontal member 315

320 second leg of alternative brake system 300

325 void defined within second leg 320

330 cable housing of alternative brake system 300

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

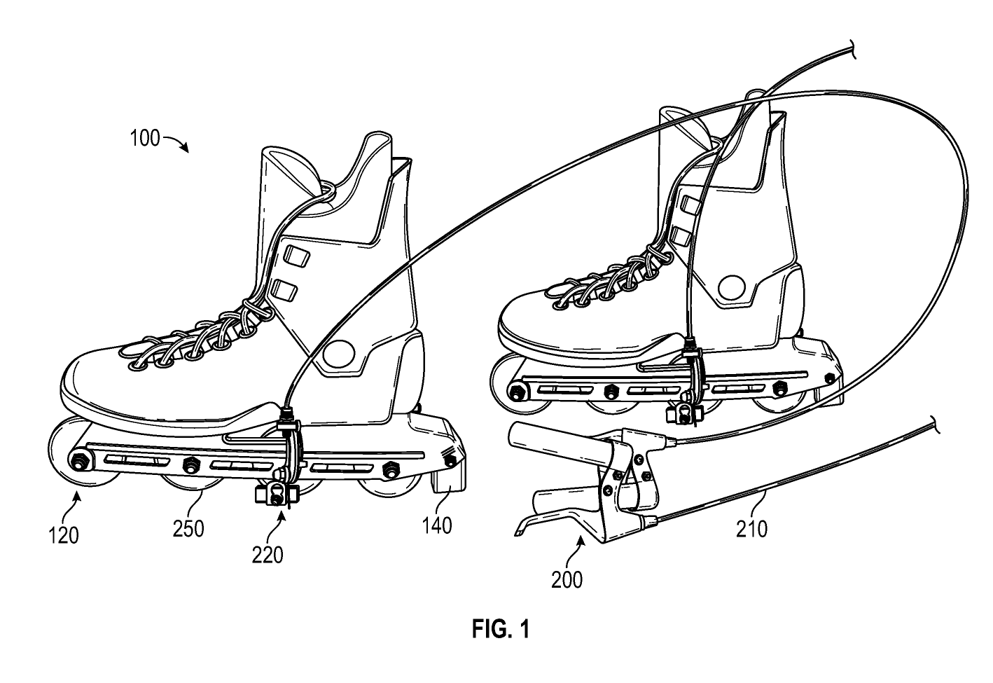

FIG. 1 two inline skates 100, a hand control system 200 and a bike type brake system 220 are depicted. The brake system may be attached to either an inline skate frame or upon a skate boot. A hand control system 200 may comprise handles and one or more cables, the cables attached to the one or more brake systems. Disclosed embodiments allow for the use of traditional back stoppers 140. FIG. 1 depicts a center wheel 250, a center wheel may be defined as a wheel located within the center area of a skate, or a wheel next to a more outer wheel.

A hand control system 200 may comprise a lever attached to the second end of a cable, and the lever attached to a handle. In order the activate a brake, the user would squeeze the lever and handle together in order to retract the cable which in turns causes one or more brake pads to contact a center wheel and retard the speed of the center wheel.

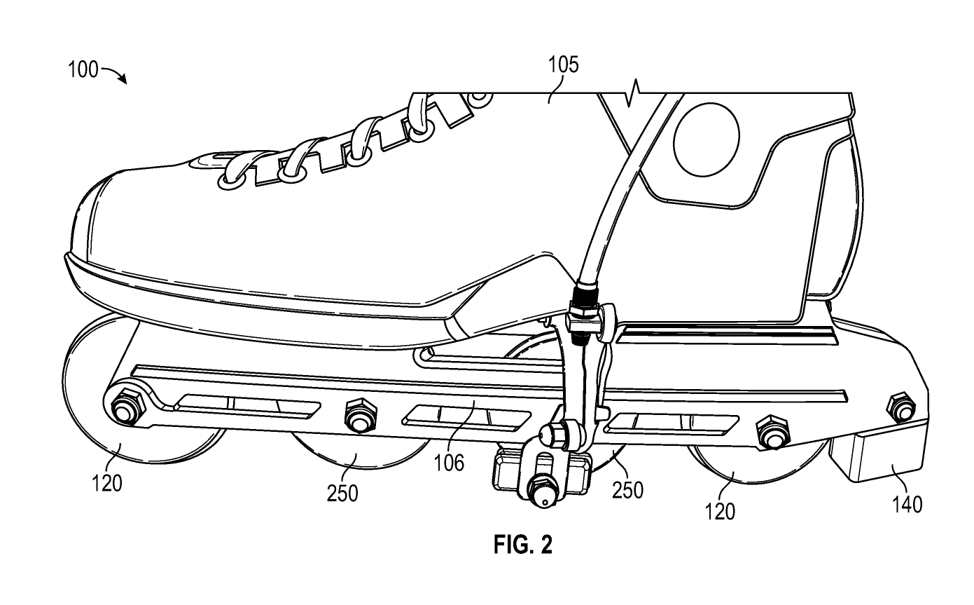

FIG. 2 depicts one inline skate 100 having a four wheels, a brake system 220 and a back stopper 140. The use of the back stopper 140 does not interfere with the disclosed embodiments. The disclosed embodiments and the back stopper easily coexist and do not interfere with one another. FIG. 2 depicts outer wheels 240 or wheels in general and two

Disclosed embodiments include the use of bicycle “side pull” brake systems or older ten speed bike brake systems using bike rubber pads, brake cables and brake lever handles. The brake systems may use brake lever handles to activate both bike pads on either side of inline skate wheels. In one disclosed embodiment, brake pads are disposed upon two middle wheels of the inline skate. Attaching brake pads upon one or two middle wheels provides an advantage in that skating maneuvers are not hampered in that the front and back wheels are unencumbered. Thus, placement of brake systems upon one or two middle wheels provides a distinct mechanical advantage.

In a disclosed embodiment, brake pads are applied to merely one side of a wheel. Such a method and system is possible as a skate wheel has a relatively sort radius as compared to the width of the hub.

In implementation, the cables are easily removed by hand or by a wrench that expands or contracts cable and cable attachment components.

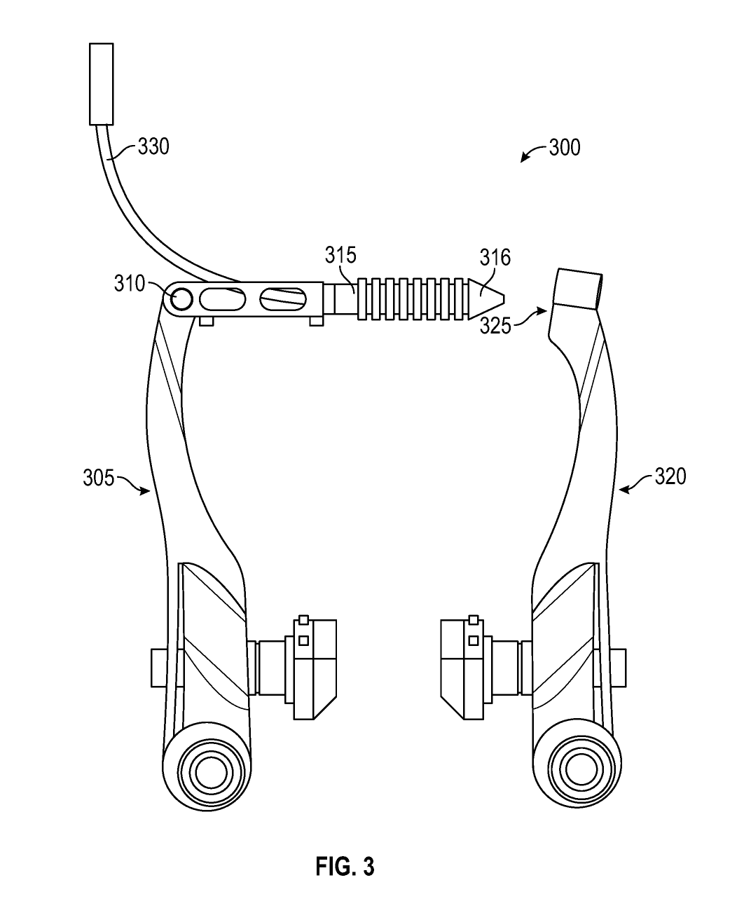

FIG. 3 depicts an alternative brake system 300 that may comprise a first leg 305 pivotally attached to a hinge or pivotal attachment 310, with the hinge or pivotal attachment hingedly attached to a horizontal member 315, the horizontal member may comprise a tip section 316, with the tip section comporting to a void 325, the void defined within a second leg 320. The horizontal section 315 may be inserted through a skate boot or an inline skate frame to secure the brake system. The use of the horizontal member to secure the brake system to the boot or frame provides a mechanical advantage in efficient of parts and in secure attachment.

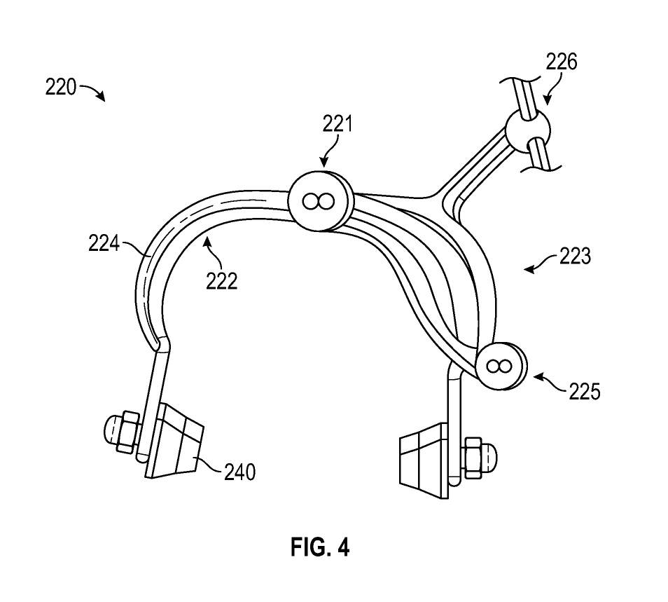

FIG. 4 depicts a brake system 220 that may comprise a center pivot and attachment assembly 221 that pivotally connects a first curved leg 222 to a second curved leg 223. In the disclosed embodiments, the center pivot and attachment assembly 221 may be attached to a skate boot, skate frame or other inline skate component. The first curved leg 222 may comprise a cable attachment end 225, having a cable leading to a hand control. The second curved leg 223 may have a cable attachment end 226 or collar that is connected to or accepts a cable, the cable leading to a hand control.

A first curved leg 222 may comprise an attachment area 224, the attachment area used to attach to a skate boot, skate frame or other inline skate component. In one disclosed embodiment, the attachment area 224 of the first curved leg 222 is attached to a skate frame, wherein the first curved leg becomes stationary. This configuration overcomes shortfalls in the art as the attachment does not interfere with use of the inline skate and an unexpected result occurs in that the moveable second curved leg 223 is able to apply sufficient brake pressure to one side of a wheel to sufficiently retard the wheel.

Items

Disclosed embodiments may include the following items:

1. A brake and brake hand control system used for an inline skate, the system comprising:

a) a brake system (220), the brake system comprising a center pivot and attachment assembly (221) pivotally attached to a first curved leg (222) and a second curved leg (223), with the first curved leg comprising a first brake pad (240) and a first cable attachment end (225), and the second curved leg comprising a second brake pad and a second cable attachment end (226);
b) a cable having a first end attached to the first cable attachment end (222) and the cable passing through the second cable attachment end (226) the cable having a second end attached to a hand control system (200);
c) the brake system disposed over a center wheel (250) of an inline skate, the brake system's (220) center pivot and attachment assembly (221) attached to a boot of the inline skate.

2. The brake and brake hand control system of 1 wherein the center pivot and attachment assembly is attached to a frame of the inline skate.

3. The brake and brake hand control system of 1 further including a second brake system attached to a second inline skate, the second brake system having a second cable having a second end attached to the hand control system (200).

4. The brake and brake hand control system of 1 further including a separate brake system (220) disposed over a second center wheel.

5. The brake and brake hand control system of 1 having an alternative brake system (300), the alternative brake system comprising a first leg 305, pivotally attached to a pivotal attachment assembly (310) with the pivotal attachment hingedly attached to a horizontal member (315) the horizontal member comprising a tip section (316) with the tip section comporting to a void (325) the void defined within a second leg (320); the horizontal section (315) inserted through an inline skate frame to secure the brake system.

6. The brake and brake hand control system of 5 wherein the horizontal section is inserted through the boot.

What is claimed is:

1. A brake and brake hand control system used with an inline skate, the system comprising:
a) a brake system (220), the brake system comprising a center pivot and attachment assembly (221) pivotally attached to a first curved leg (222) and a second curved leg (223), with the first curved leg comprising a first brake pad (240) and a first cable attachment end (225), and the second curved leg comprising a second brake pad and a second cable attachment end (226);
b) a cable having a first end attached to the first cable attachment end (222) and the cable passing through the second cable attachment end (226) the cable having a second end attached to a hand control system (200); the hand control system comprising a lever hingedly attached to a handle; and
c) the brake system disposed over a center wheel (250) of an inline skate, the brake system's (220) center pivot and attachment assembly (221) attached to a boot of the inline skate.

2. The brake and brake hand control system of claim 1 wherein the center pivot and attachment assembly (221) is attached to a frame of the inline skate.

3. The brake and brake hand control system of claim 1 further including a second brake system attached to a second inline skate, the second brake system having a second cable having a second end attached to the lever of the hand control system (200).

4. The brake and brake hand control system of claim 1 further including a separate brake system (220) disposed over a second center wheel.

5. The brake and brake hand control system of claim 1 having an alternative brake system (300), the alternative brake system comprising a first leg 305, pivotally attached to a pivotal attachment assembly (310) with the pivotal attachment hingedly attached to a horizontal member (315) the horizontal member comprising a tip section (316) with the tip section comporting to a void (325) the void (325) defined within a second leg (320); the horizontal section (315) inserted through an inline skate frame to secure the brake system.

6. The break and brake hand control system of claim 5 wherein the horizontal section is inserted through the boot.
